(19) United States
(12) Patent Application Publication
(10) Pub. No.: US 2023/0001730 A1
(43) Pub. Date: Jan. 5, 2023

(54) THERMAL TRANSFER RECORDING MEDIUM AND TRANSFERRED PRODUCT

(71) Applicants: Takaki Hayashi, Shizuoka (JP); Yu Tsuchimura, Shizuoka (JP); Yoshihiko Hiyoshi, Shizuoka (JP)

(72) Inventors: Takaki Hayashi, Shizuoka (JP); Yu Tsuchimura, Shizuoka (JP); Yoshihiko Hiyoshi, Shizuoka (JP)

(73) Assignee: Ricoh Company, Ltd., Tokyo (JP)

(21) Appl. No.: 17/756,216

(22) PCT Filed: Dec. 25, 2020
(86) PCT No.: PCT/JP2020/049023

§ 371 Date: May 19, 2022

(30) Foreign Application Priority Data
Dec. 27, 2019 (JP) 2019-237746

(51) Int. Cl. B41M 5/42; B41M 5/382

(52) U.S. Cl. CPC B41M 5/42; B41M 5/38214; B41M 2205/06

(57) ABSTRACT

A thermal transfer recording medium includes a base, a release layer disposed on or above the base, and a thermally fusible ink layer disposed on or above the release layer. The release layer includes wax and ethylene-propylene-ethylidene norbornene rubber.

### TECHNICAL FIELD

The present disclosure relates to a thermal transfer recording medium and a transferred product.

### BACKGROUND ART

A thermal transfer recording system using a thermal head etc. has been widely used because the thermal transfer recording system has advantages, such as noiseless, use of a relatively inexpensive and small device, easy maintenance, and stable printed images.

An image transferred from a thermal transfer recording medium used in the thermal transfer recording system is desired to have image durability, such as abrasion resistance and scratch resistance. Therefore, it is important that the image transfer recording medium can give high image durability.

The image durability is largely influenced by a material of a release layer of a thermal transfer recording medium. As a conventional technology for improving image durability, for example, proposed is a thermal transfer recording medium that includes, on or above a support (base), a laminate including at least a release layer and an ink layer (thermally fusible ink layer) where the release layer includes polyethylene wax as a main component, and the ink layer includes a colorant and wax. In the proposed thermal transfer recording medium, the number average molecular weight of the polyethylene wax is 655 or greater but 1,000 or less, melt viscosity at 149 degrees Celsius is 5 cp or greater but 12 cp or less, a melting point is 99 degrees Celsius or higher but 113 degrees Celsius or lower, the wax included in the release layer and the ink layer has an endothermic peak represented with a differential thermal analysis (DTA) curve, which is obtained by plotting a temperature on a horizontal axis and an endothermic value per unit time on a vertical axis. A temperature at which the endothermic value becomes the maximum is referred to as a melting point, and the polyethylene wax included in the release layer has a melting point higher than a melting point of the wax included in the ink layer (melting point of polyethylene wax in release layer>melting point of wax in ink layer). In addition, the enthalpy of fusion [Q] of the wax in the ink layer determined by DTA is 21<Q<38 [mj/mg] (see, for example, PTL 1).

Moreover, provided is a thermal transfer recording medium including a release layer disposed on or above a support (base) and a thermal transfer layer (thermally fusible ink layer), which is a single layer and disposed on or above the release layer. The release layer includes, as a main component, was obtained by esterifying montan wax. The single-layer thermal transfer layer includes a binder resin that is a thermoplastic resin having a glass transition temperature of 50 degrees Celsius or lower (see, for example, PTL 2).

It is possible to improve scratch resistance according to the technology described above, but there is a problem that binding strength between a base and a release layer is not sufficient thus a material of the thermally fusible ink layer is transferred to the base.

In order to make binding strength with a base appropriately, moreover, proposed is a thermal transfer sheet (thermal transfer recording medium), which includes a base, a release layer disposed on one side of the base, and a transfer layer (thermally fusible ink layer) disposed on the release layer. The transfer layer is provided in a manner that the transfer layer can be peeled from the release layer. The release layer includes a thermoset resin, and a peel force adjuster. The peel force adjuster is a thermoplastic resin having a glass transition temperature (Tg) of 30 degrees Celsius or higher but 130 degrees Celsius or lower, or a hydroxyl group-containing resin having a hydroxyl value of 3 mgKOH/g or greater but 31 mgKOH/g or less, or both. The thermoplastic resin having a glass transition temperature (Tg) of 30 degrees Celsius or higher but 130 degrees Celsius or lower is at least one selected from the group consisting of a thermoplastic acryl resin, a rosin ester resin, a styrene-based resin, an ethylene-vinyl acetate copolymer, and styrene-butadiene rubber. An amount of the peel force adjuster relative to a total mass of the release layer is 10% by mass or greater but 45% by mass or less (see, for example, PTL 3).

According to the proposed technology described above, appropriate binding strength between a base and a release layer can be secured, but scratch resistance is not sufficient. Therefore, a thermal transfer recording medium satisfying all desirable qualities has not yet provided.

### CITATION LIST

### Patent Literature

PTL 1: Japanese Patent No. 4907397

PTL 2: Japanese Patent No. 3021475

PTL 3: Japanese Patent No. 6402840

### SUMMARY OF INVENTION

### Technical Problem

The present disclosure has an object to provide a thermal transfer recording medium that can form a transfer image having excellent scratch resistance and can achieve excellent binding strength between a base and a release layer.

### Solution to Problem

According to one aspect of the present disclosure, a thermal transfer recording medium includes a base, a release layer disposed on or above the base, and a thermally fusible ink layer disposed on or above the release layer, wherein the release layer includes wax and ethylene-propylene-ethylidene norbornene rubber.

### Advantageous Effects of Invention

The present disclosure can provide a thermal transfer recording medium that can form a transfer image having excellent scratch resistance and can achieve excellent binding strength between a base and a release layer.

### BRIEF DESCRIPTION OF DRAWINGS

FIG. 1 is a schematic view illustrating one example of the thermal transfer recording medium of the present disclosure.

### DESCRIPTION OF EMBODIMENTS

(Thermal Transfer Recording Medium)

The thermal transfer recording medium of the present disclosure includes a base, a release layer disposed on or above the base, and a thermally fusible ink layer disposed on or above the release layer. The release layer includes wax and ethylenepropylene-ethylidene norbornene rubber.

<Base>

The base is not particularly limited and may be appropriately selected depending on the intended purpose. Examples of the base include various plastic films, such as a polyethylene terephthalate film, a polyester film, a polycarbonate film, a polyimide film, a polyamide film, a polystyrene film, a polysulfone film, a polypropylene film, a polyethylene film, and a cellulose acetate film. Among the above-listed examples, a polyethylene terephthalate film is preferable because of strength, heat resistance, and heat conductivity thereof.

The average thickness of the base is not particularly limited and may be appropriately selected depending on the intended purpose. The average thickness of the base is preferably 3 micrometers or greater but 10 micrometers or less.

<Release Layer>

The release layer has a function of facilitating peeling between the base and the thermal fusible ink layer at the time of printing. Once the release layer is heated by a thermal head, the release layer is melted by heat to become a low-viscous liquid. Therefore, the thermally fusible ink layer can be easily cut off at an area adjacent to an interface between the heated area and the unheated area.

The release layer includes wax, and, as a binder, ethylene-propylene-ethylidene norbornene rubber. The release layer preferably further includes another binder, and a dispersant. The release layer may further include other components according to the necessity.

—Binder—

The binder includes ethylene-propylene-ethylidene norbornene rubber because of excellent binding strength to the base, and excellent image durability. The binder may further include other components according to the necessity. The ethylidene norbornene content of the ethylene-propylene-ethylidene norbornene rubber is preferably 4.5% by mass or greater. When the ethylidene norbornene content of the ethylene-propylene-ethylidene norbornene rubber is 4.5% by mass or greater, a transfer image having excellent scratch resistance can be formed as well as improving binder strength between the base and the release layer.

The above-mentioned another binder is not particularly limited and may be appropriately selected depending on the intended purpose. Examples thereof include an ethylene-vinyl acetate copolymer, a partially saponified ethylene-vinyl acetate copolymer, an ethylene-vinyl alcohol copolymer, an ethylene-sodium methacrylate copolymer, polyamide, polyester, polyurethane, polyvinyl alcohol, methylcellulose, carboxymethyl cellulose, starch, polyacrylic acid, an isobutylene-maleic acid copolymer, a styrene-maleic acid copolymer, polyacrylamide, polyvinyl acetal, polyvinyl chloride, polyvinylidene chloride, isoprene rubber, styrene-butadiene rubber, ethylene-propylene rubber, butyl rubber, and acrylonitrile-butadiene rubber. The above-listed examples may be used alone or in combination.

An amount of the ethylene-propylene-ethylidene norbornene rubber is preferably 5 parts by mass or greater but 30 parts by mass or less, and more preferably 10 parts by mass or greater but 25 parts by mass or less, relative to 100 parts by mass of the wax in the release layer. When the amount of the ethylene-propylene-ethylidene norbornene rubber is 5 parts by mass or greater but 30 parts by mass or less, binding strength between the base and the release layer is not excessively strong, and therefore a problem of migrating a material of the thermally fusible ink layer thermal sensitivity to the base can be prevented as well as preventing thermal sensitivity of the thermally fusible ink layer.

—Wax of Release Layer—

The wax of the release layer is not particularly limited and may be appropriately selected depending on the intended purpose. Examples of the wax include Fischer-Tropsch wax, paraffin wax, microcrystalline wax, oxidized paraffin wax, candelilla wax, carnauba wax, rice wax, montan wax, ceresin wax, polyethylene wax, oxidized polyethylene wax, castor wax, beef tallow hydrogenated oil, lanolin, Japan wax, sorbitan stearate, sorbitan palmitate, stearyl alcohol, polyamide wax, oleyl amide, stearyl amide, hydroxystearic acid, and synthetic ester wax. The above-listed examples may be used alone or in combination. Among the above-listed examples, Fischer-Tropsch wax, polyethylene wax, and carnauba wax are preferable.

The average particle diameter of the wax is preferably 1.0 micrometer or greater but 6.0 micrometers or less, and more preferably 2.0 micrometers or greater but 4.0 micrometers or less. When the average particle diameter of the wax is 1.0 micrometer or greater but 6.0 micrometers or less, thermal sensitivity is improved, and a highly precise printed image is obtained.

For example, the average particle diameter can be determined with the state of the particles of the wax observed on the cross-section of the release layer of the thermal transfer recording medium. The cross-sectional observation can be performed by preparing a sample according to a conventional method, and measuring the sample using a transmission electron microscope (TEM). The measured value of the particle diameter of the wax obtained by the TEM observation is substantially matched with a measurement value of a particle diameter of the wax in a release layer coating liquid used for forming the release layer. Therefore, the particle size distribution of the wax in the formed release layer can be set by adjusting the particle size distribution of the wax in the release layer coating liquid. For example, the volume average particle diameter of the wax in the release layer coating liquid can be measured by a laser scanning particle size analyzer LA-960, available from HORIBA, Ltd., etc.

A melting point of the wax is preferably 70 degrees Celsius or higher but 120 degrees Celsius or lower, and more preferably 80 degrees Celsius or higher but 100 degrees Celsius or lower. When the melting point of the wax is 70 degrees Celsius or higher but 120 degrees Celsius or lower, excellent thermal sensitivity, abrasion resistance, and scratch resistance are obtained.

A penetration degree of the wax is preferably 3 or less. When the penetration degree of the wax is 3 or less, excellent abrasion resistance and scratch resistance are obtained.

—Dispersant—

In the case where the release layer is formed with an aqueous emulsion or aqueous dispersion coating liquid, wax is dispersed into small particles. Therefore, a dispersant is preferably added to the emulsion or dispersion coating liquid.

The dispersant is not particularly limited and may be appropriately selected depending on the intended purpose. Examples of the dispersant include an anionic surfactant, a cationic surfactant, and a nonionic surfactant. Among the above-listed examples, a nonionic surfactant is preferable in view of dispersibility.

The nonionic surfactant is not particularly limited and may be appropriately selected depending on the intended purpose. Examples of the nonionic surfactant include: fatty acids, such as glycerin fatty acid ester, sucrose fatty acid ester, sorbitan fatty acid ester, polyoxyethylene sorbitan fatty acid ester, polyoxyethylene fatty acid ester, and fatty acid alkanol amide; polyoxyethylene alkyl ethers, such as polyoxyethylene lauryl ether, polyoxyethylene stearyl ether, and polyoxyethylene oleyl ether; higher alcohols, such as alkyl glucoside; polyoxyethylene alkyl phenyl ethers, such as polyoxyethylene octyl phenyl ether, and polyoxyethylene nonyl phenyl ether; polyoxyethylene dialkyl esters, such as polyoxyethylene dilaurate, and polyoxyethylene distearate; and polyoxyethylene-polyoxypropylene block copolymer. The above-listed examples may be used alone or in combination. Among the above-listed examples, sorbitan fatty acid ester, polyoxyethylene (POE) fatty acid ester, and polyoxyethylene (POE) alkyl ether are preferable, and polyoxyethylene (POE) alkyl ether is more preferable in view of dispersibility.

An amount of the nonionic surfactant in the release layer is not particularly limited and may be appropriately selected depending on the intended purpose. The amount of the nonionic surfactant is preferably 2 parts by mass or greater but 10 parts by mass or less, and more preferably 3 parts by mass or greater but 6 parts by mass or less, relative to 100 parts by mass of wax contained in the release layer. When the amount of the nonionic surfactant is 2 parts by mass or greater, the wax is formed into particles of small particle diameters in an aqueous emulsion or aqueous dispersion liquid. When the amount of the nonionic surfactant is 10 parts by mass or less, moreover, transfer performance to paper having low smoothness is excellent, and therefore abrasion resistance of an image improves.

—Other Components—

The above-mentioned other components are not particularly limited and may be appropriately selected depending on the intended purpose. Examples thereof include a dispersion aid, and a solvent.

The release layer can be formed by applying a release layer coating liquid onto the base by coating, followed by drying. The release layer coating liquid includes the wax, the binder, the dispersant, and optionally the above-mentioned other components. Examples of the coating include gravure coating, wire bar coating, and roll coating.

The average thickness of the release layer is not particularly limited and may be appropriately selected depending on the intended purpose. The average thickness of the release layer is preferably 0.2 micrometers or greater but 1.0 micrometer or less, and more preferably 0.3 micrometers or greater but 0.8 micrometers or less. When the average thickness of the release layer is 0.2 micrometers or greater but 1.0 micrometer or less, excellent thermal sensitivity, abrasion resistance, and scratch resistance are obtained.

<Thermally Fusible Ink Layer>

The thermally fusible ink layer preferably includes wax and a colorant. More preferably, the thermally fusible ink layer further includes organic fatty acid and long-chain alcohol. The thermally fusible ink layer may further include other components according to the necessity.

—Wax of Thermally Fusible Ink Layer—

The wax of the thermally fusible ink layer is not particularly limited and may be appropriately selected depending on the intended purpose. Examples of the wax include paraffin wax, microcrystalline wax, oxidized paraffin wax, candelilla wax, carnauba wax, rice wax, montan wax, ceresin wax, polyethylene wax, oxidized polyethylene wax, castor wax, beef tallow hydrogenated oil, lanolin, Japan wax, sorbitan stearate, sorbitan palmitate, stearyl alcohol, polyamide wax, oleylamide, stearylamide, hydroxystearic acid, and synthetic ester wax. The above-listed examples may be used alone or in combination. Among the above-listed examples, carnauba wax is preferable.

Since the carnauba wax is hard wax having a penetration degree of 1 or less, use of the carnauba wax improves abrasion resistance of the thermally fusible ink layer. Moreover, the carnauba wax give excellent thermal sensitivity because a melting point of the carnauba wax is low, i.e., 80 degrees Celsius. Furthermore, the carnauba wax give an advantage that excellent printing performance can be obtained because the carnauba wax has sharp thermal characteristics, and has low melt viscosity.

The wax is preferably included in the form of an aqueous emulsion together with organic fatty acid or long-chain alcohol, or both. In this case, the thermally fusible ink layer is preferentially cut and peeled at a boundary of each particle constituting the emulsion to be transferred onto a surface of the transfer target at the time when the thermal transfer recording medium is heated with a thermal head. Therefore, very charge edges of a printed image or letters on the transfer target can be obtained. Moreover, environmental load is kept minimum because the emulsion for use is water-base.

A formation method of the aqueous emulsion of the wax is not particularly limited and may be appropriately selected depending on the intended purpose. For example, the wax can be emulsified using, as an emulsifier, a salt generated by adding the organic fatty acid and the below-mentioned organic base into the fluid.

—Colorant—

The colorant is not particularly limited and may be appropriately selected depending on the intended purpose. Examples of the colorant include carbon black, azo-based dyes and pigments, phthalocyanine, quinacridone, anthraquinone, perylene, quinophthalone, aniline black, titanium oxide, zinc flower, and chromium oxide. The above-listed examples may be used alone or in combination. Among the above-listed examples, carbon black is preferable.

—Organic Fatty Acid—

The organic fatty acid is not particularly limited and may be appropriately selected depending on the intended purpose. Examples of the organic fatty acid include montanoic acid, oleic acid, and behenic acid. The above-listed examples may be used alone or in combination.

An acid value of the organic fatty acid is preferably 90 mgKOH/g or greater but 200 mgKOH/g or less, and more preferably 140 mgKOH/g or greater but 200 mgKOH/g or less.

When the acid value of the organic fatty acid is 90 mgKOH/g or greater but 200 mgKOH/g or less, the organic fatty acid is reacted with alkali to form an anionic emulsifier. Therefore, the wax can be emulsified without adversely affecting sensitivity and smear resistance.

A melting point of the organic fatty acid is preferably 70 degrees Celsius or higher but 90 degrees Celsius or lower. When the melting point is within the above-mentioned preferable range, excellent sensitivity is obtained because the melting point of the organic fatty acid is close to the melting point of the wax.

An amount of the organic fatty acid in the thermally fusible ink layer is not particularly limited and may be appropriately selected depending on the intended purpose. The amount of the organic fatty acid in the thermally fusible ink layer is preferably 1 part by mass or greater but 6 parts by mass or less, relative to 100 parts by mass of the wax.

When the amount of the organic fatty acid is 1 part by mass or greater but 6 parts by mass or less relative to 100 parts by mass of the wax, the wax can be efficiently emulsified, and blooming of the wax can be prevented.

—Long-Chain Alcohol—

The long-chain alcohol is not particularly limited and may be appropriately selected depending on the intended purpose. The long-chain alcohol is preferably aliphatic alcohol.

The long-chain may be formed only of a straight chain, or may include a branched chain.

The long-chain alcohol is not particularly limited and may be appropriately selected depending on the intended purpose. The long-chain alcohol is preferably long-chain alcohol represented by General Formula (1) below, or long-chain alcohol represented by General Formula (2), or both.

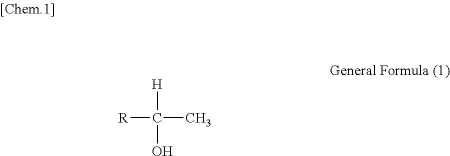

In General Formula (1), R is an alkyl group having 28 carbon atoms or more but 38 carbon atoms or less.

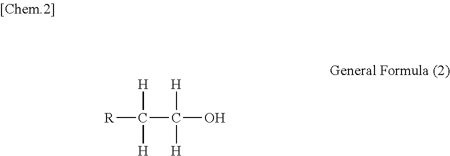

In General Formula (2), R is an alkyl group having 28 carbon atoms or more but 38 carbon atoms or less.

When the number of carbon atoms of the alkyl group of R is 28 or greater but 38 or less, an effect of suppressing blooming can be obtained.

The wax is completely melted once, when an aqueous emulsion of the wax is formed. As time passes, however, the wax may appear on the surface of the thermally fusible ink layer as blooming because the wax has characteristics of supercooling even after being cooled. If the thermal transfer recording medium is stored in the form of a roll, therefore, a surface of the backing layer may be soiled. Use of the long-chain alcohol having 28 or more carbon atoms but 38 or less carbon atoms as R in General Formula (1) or General Formula (2) is advantageous because blooming of the wax can be suppressed.

A melting point of the long-chain alcohol represented by General Formula (1) and a melting point of the long-chain alcohol represented by General Formula (2) are not particularly limited and may be appropriately selected depending on the intended purpose. The melting points thereof are preferably 70 degrees Celsius or higher but 90 degrees Celsius or lower.

When the melting point of the long-chain alcohol is within the above-mentioned numerical range, excellent sensitivity can be obtained because the melting point thereof is close to the melting point of the wax.

An amount of the long-chain alcohol represented by General Formula (1) or the long-chain alcohol represented by General Formula (2) or both in the thermally fusible ink layer is not particularly limited and may be appropriately selected depending on the intended purpose. The amount thereof is preferably 6 parts by mass or greater but 12 parts by mass or less relative to 100 parts by mass of the wax.

When the amount thereof is 6 parts by mass or greater but 12 parts by mass or less, an effect of suppressing blooming and excellent sensitivity are obtained.

—Other Components—

The above-mentioned other components are not particularly limited and may be appropriately selected depending on the intended purpose. Examples thereof include an organic base, a dispersant, a binder, a dispersion aid, and a solvent.

—−Organic Base——

The organic base is preferably used together with the organic fatty acid when the wax is emulsified.

The organic base is not particularly limited and may be appropriately selected depending on the intended purpose. The organic base is preferably morpholine because morpholine is easily evaporated after drying.

An amount of the organic base in the thermally fusible ink layer is not particularly limited and may be appropriately selected depending on the intended purpose. The amount of the organic base is preferably 0.5 parts by mass or greater but 5 parts by mass or less, relative to 100 parts by mass of the wax.

——Dispersant——

When the dispersant is added, particle size of the wax in the aqueous emulsion can be made small, cohesive force of the thermally fusible ink layer improves, and scumming can be prevented.

The dispersant is not particularly limited and may be appropriately selected depending on the intended purpose. The dispersant is preferably a nonionic surfactant, and more preferably polyoxyethylene (POE) oleyl ether.

An amount of the dispersant in the thermally fusible ink layer is not particularly limited and may be appropriately selected depending on the intended purpose. The amount of the dispersant is preferably 2 parts by mass or greater but 7 parts by mass or less relative to 100 parts by mass of the wax.

——Binder——

Examples of the binder include an acrylic resin, a polyester resin, a polyethylene resin, an ethylene-vinyl acetate copolymer, an ethylene-acrylate copolymer, a urethane resin, cellulose, a vinyl chloride-vinyl acetate copolymer, a petroleum resin, a rosin resin or derivative thereof, and a polyamide resin.

The binder is preferably a binder having desirable properties, such as excellent abrasion resistance and chemical resistance. Since there is a case where a conventional thermal transfer printer may apply an insufficient amount of heat, the binder is preferably added in an amount with which the binder resin added does not adversely affect sensitivity of the thermal transfer recording medium.

The thermally fusible ink layer can be formed by applying a thermally fusible ink layer coating liquid onto the release layer by coating, followed by drying. The thermally fusible ink layer coating liquid includes the wax, the colorant, the organic fatty acid, the long-chain alcohol, and optionally the above-mentioned other components. Examples of the coating include gravure coating, wire bar coating, and roll coating.

The average thickness of the thermally fusible ink layer is not particularly limited and may be appropriately selected depending on the intended purpose. The average thickness of the thermally fusible ink layer is preferably 1.0 micrometer or greater but 2.0 micrometers or less, and more preferably 1.2 micrometers or greater but 1.8 micrometers or less. When the average thickness of the thermally fusible ink layer is 1.0 micrometer or greater but 2.0 micrometers or less, excellent thermal sensitivity and image transfer performance are obtained.

<Other Layers>

The above-mentioned other layers are not particularly limited and may be appropriately selected depending on the intended purpose. Examples thereof include an overlying layer, and a backing layer.

—Overlying Layer—

The thermal transfer recording medium may include an overlying layer disposed on the thermally fusible ink layer in order to prevent scumming. In the case where the overlying layer is disposed, however, a thickness of an entire ink surface increases. Therefore, the overlying layer is preferably disposed in a manner that the overlying layer does not adversely affect heat effectively applied to the thermally fusible ink layer with a thermal head.

The overlying layer includes wax, and may further include other components according to the necessity.

As the wax, any wax usable as the wax of the thermally fusible ink layer can be used. In view of abrasion resistance and sensitivity, the wax is preferably carnauba wax.

Examples of the above-mentioned other components include a binder, a dispersant, and a solvent.

The average thickness of the overlying layer is not particularly limited and may be appropriately selected depending on the intended purpose. The average thickness of the overlying layer is preferably 0.5 micrometers or greater but 1.5 micrometers or less.

—Backing Layer—

The backing layer is preferably disposed on the opposite side of the base to the side thereof on which the thermally fusible ink layer has been formed. Since heat is directly applied to the opposite side of the base by a thermal head etc. corresponding to an image at the time of transferring, the backing layer preferably has resistance to high temperatures and durability against frictions, such as frictions with the thermal head. The backing layer includes a binder, and may further include particles and a lubricant according to the necessity.

Examples of the binder include a silicone-modified urethane resin, a silicone-modified acryl resin, a silicone resin, silicone rubber, a fluororesin, a polyimide resin, an epoxy resin, a phenol resin, a melamine resin, and nitrocellulose.
Examples of the particles include talc, silica, and organopolysiloxane.
The average thickness of the backing layer is not particularly limited and may be appropriately selected depending on the intended purpose. The average thickness of the backing layer is preferably 0.01 micrometers or greater but 1.0 micrometer or less.

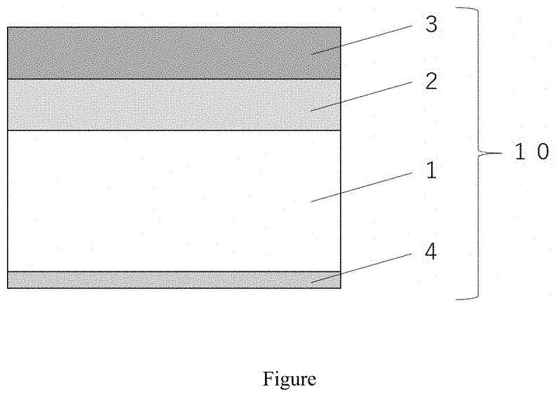

FIG. 1 is a schematic view illustrating one example of the thermal transfer recording medium of the present disclosure. The thermal transfer recording medium 10 of FIG. 1 includes a base 1, a release layer 2 disposed on the base 1, and a thermally fusible ink layer 3 disposed on the release layer 2. Moreover, the thermal transfer recording medium 10 includes a backing layer 4 disposed on the side of the base 1 where the thermally fusible ink layer 3 is not disposed. Although it is omitted from the FIGURE, an overlying layer may be disposed on the thermally fusible ink layer 3.

<Thermal Transfer Method>

A thermal transfer method of the thermal transfer recording medium of the present disclosure is a method where the thermally fusible ink layer of the thermal transfer recording medium of the present disclosure is thermally transferred to a transfer target.

The transfer target is not particularly limited and may be appropriately selected depending on the intended purpose. Examples of the transfer target include: films, such as a polyester film, a polyolefin film, a polyamide film, and a polystyrene film; paper, such as synthetic paper, washing-resistant paper, light-weight coated paper, cast coated paper, and art paper; cardboard cards, such as polyvinyl chloride (PVC), polyethylene terephthalate (PET), and cardboard; fabrics, such as nylon, polyester, cotton, and nonwoven fabric; laminates of the films; and the films subjected to surface treatments, such as matt processing, a corona treatment, and metal vapor deposition. The above-listed examples may be used alone or in combination.

The thermal transfer is preferably performed by means of a heating unit.

Examples of the heating unit include a serial thermal head, and a line thermal head.

(Transferred Product)

The transferred product of the present disclosure is obtained by thermally transferring part of the thermally fusible ink layer from the thermal transfer recording medium of the present disclosure to a transfer target.

The transfer target may be any of the transfer targets usable in the thermal transfer method.

The thermal transfer may be any method of the thermal transfer usable in the thermal transfer method.

### EXAMPLES

Examples of the present disclosure will be described hereinafter. However, the present disclosure should not be construed as being limited to these Examples.

<Average Particle Diameter of Thermally Fusible Material (Wax) of Release Layer>

The average particle diameter was determined by the state of the thermally fusible material (wax) observed on the cross-section of the release layer of the thermal transfer recording medium. The cross-section observation was performed by preparing a sample according to a conventional method, taking a cross-section TEM photograph of the sample by means of a transmission electron microscope (TEM, JEM-210, available from JEOL Ltd.), measuring the particle diameter of each of 5 particles of the thermally fusible material (wax), and determining an average value of the measured values as an average particle diameter of the thermally fusible material (wax).

<Average Thickness of Release Layer>

A thickness of the release layer was measured at 3 positions by means of a transmission electron microscope (TEM, JEM-210, available from JEOL Ltd.), and the average value of the measured values was determined as an average thickness of the release layer.

<Melting Point of Wax>

A melting point of the wax was measured by means of a differential scanning calorimeter (DSC, DSC-6220, available from Hitachi High-Tech Corporation). The heating rate was 10 degrees Celsius/min, and the amount of the sample was 10 mg.

<Penetration Degree of Wax>

A penetration degree of the wax was measured by means of a penetration meter (available from YASUDA SEIKI SEISAKUSHO, LTD.) at an atmospheric temperature of 22 degrees Celsius, and humidity of 60%.

### Example 1

<Production of Thermal Transfer Recording Medium>—Preparation of Thermally Fusible Ink Layer Coating Liquid—

After dissolving 100 parts by mass of carnauba wax powder (available from S. KATO & CO.), 2 parts by mass of montanoic acid (acid value: 132 mgKOH/g, melting point: 80 degrees Celsius), and 9 parts by mass of the long-chain alcohol represented by General Formula (1) (R: alkyl group having from 28 through 38 carbon atoms, melting point: 75 degrees Celsius) at 120 degrees Celsius, 5 parts by mass of morpholine was added to the resultant mixture with stirring.

Next, hot water of 90 degrees Celsius was added to the mixture dropwise to give a solid content of 30% by mass to form an O/W emulsion. Thereafter, the resultant was cooled to obtain an aqueous emulsion including 30% by mass of carnauba wax in solid content.
The volume average particle diameter of the obtained aqueous emulsion was measured by means of a laser scattering particle size distribution analyzer (LA-960, available from HORIBA, Ltd.). As a result, the volume average particle diameter was 0.4 micrometers.
Next, 80 parts by mass of the aqueous emulsion of the carnauba wax (solid content: 30% by mass) and 20 parts by mass of an aqueous dispersion of carbon black (#44, available from Mitsubishi Chemical Corporation) having a solid content of 30% by mass were mixed to obtain a thermally fusible ink layer coating liquid.

—Preparation of Release Layer Coating Liquid—

To 100 parts by mass of paraffin wax (HNP-3, available from NIPPON SEIRO CO., LTD., melting point: 60 degrees Celsius, penetration degree: 3) serving as wax and 10 parts by mass of ethylene-propylene-ethylidene norbornene rubber (EP51, available from JSR Corporation, ethylidene norbornene content: 5.8% by mass) serving as a binder, toluene and methyl ethyl ketone were added to give a solid content of 10% by mass, and the resultant mixture was dispersed to obtain a release layer coating liquid.

—Preparation of Backing Layer Coating Liquid—

Silicone rubber (SD7226, available from DuPont Toray Specialty Materials Kabushiki Kaisha) in an amount of 16.8 parts by mass, 0.2 parts by mass of a chloroplatinic acid catalyst, and 83 parts by mass of toluene were mixed to obtain a backing layer coating liquid.

Next, the backing layer coating liquid was applied onto one side of a polyester film serving as a base and having an average thickness of 4.5 micrometers, and the resultant was dried at 80 degrees Celsius for 10 seconds to form a backing layer having the average thickness of 0.02 micrometers.

Next, the release layer coating liquid was applied onto the opposite side of the polyester film to the side where the backing layer had been formed, and the resultant was dried at 45 degrees Celsius for 15 seconds to form a release layer having the average thickness of 0.5 micrometers.

Next, the thermally fusible ink layer coating liquid was applied onto the release layer, and the resultant was dried at 70 degrees Celsius for 10 seconds to form a thermally fusible ink layer having the average thickness of 1.7 micrometers. In the manner as described above, a thermal transfer recording medium was produced.

Next, thermal transfer recording media of Examples 2 to 19 and Comparative Examples 1 to 5 were each produced using the wax and the binder resin of the release layer coating liquid presented in Table 1.

In Examples and Comparative Examples below, the average thickness was the value measured through the cross-section TEM observation, the melting point was the value measured by DSC, and the penetration degree was value measured by means of the penetration meter.

### Example 2

A thermal transfer recording medium was produced in the same manner as in Example 1, except that candelilla wax (available from S. KATO & CO., melting point: 70 degrees Celsius, penetration degree: 2) was used as the wax of the release layer coating liquid.

### Example 3

A thermal transfer recording medium was produced in the same manner as in Example 1, except that carnauba wax (available from S. KATO & CO., melting point: 85 degrees Celsius, penetration degree: 2) was used as the wax of the release layer coating liquid.

### Example 4

A thermal transfer recording medium was produced in the same manner as in Example 1, except that polyethylene wax (4052E, available from Mitsui Chemicals, Inc., melting point: 120 degrees Celsius, penetration degree: 2) was used as the wax of the release layer coating liquid.

### Example 5

A thermal transfer recording medium was produced in the same manner as in Example 1, except that polyethylene wax (400PF, available from Mitsui Chemicals, Inc., melting point: 130 degrees Celsius, penetration degree: 2) was used as the wax of the release layer coating liquid.

### Example 6

A thermal transfer recording medium was produced in the same manner as in Example 1, except that paraffin wax (HNP-51, available from NIPPON SEIRO CO., LTD., melting point: 85 degrees Celsius, penetration degree: 3) was used as the wax of the release layer coating liquid.

### Example 7

A thermal transfer recording medium was produced in the same manner as in Example 1, except that Fischer-Tropsch wax (SX-80, available from NIPPON SEIRO CO., LTD., melting point: 85 degrees Celsius, penetration degree: 4) was used as the wax of the release layer coating liquid.

### Example 8

A thermal transfer recording medium was produced in the same manner as in Example 3, except that ethylene-propylene-ethylidene norbornene rubber (EP93, available from JSR Corporation, ethylidene norbornene content: 2.7% by mass) was used as the binder of the release layer coating liquid.

### Example 9

A thermal transfer recording medium was produced in the same manner as in Example 3, except that ethylene-propylene-ethylidene norbornene rubber (EP22, available from JSR Corporation, ethylidene norbornene content: 4.5% by mass) was used as the binder of the release layer coating liquid.

### Example 10

A thermal transfer recording medium was produced in the same manner as in Example 3, except that ethylene-propylene-ethylidene norbornene rubber (EP33, available from JSR Corporation, ethylidene norbornene content: 8.1% by mass) was used as the binder of the release layer coating liquid.

### Example 11

A thermal transfer recording medium was produced in the same manner as in Example 3, except that ethylene-propylene-ethylidene norbornene rubber (EP331, available from JSR Corporation, ethylidene norbornene content: 11.3% by mass) was used as the binder of the release layer coating liquid.

### Example 12

A thermal transfer recording medium was produced in the same manner as in Example 3, except that the amount of the binder resin relative to 100 parts by mass of the wax of the release layer coating liquid was changed to 4 parts by mass.

### Example 13

A thermal transfer recording medium was produced in the same manner as in Example 3, except that the amount of the binder resin relative to 100 parts by mass of the wax of the release layer coating liquid was changed to 5 parts by mass.

### Example 14

A thermal transfer recording medium was produced in the same manner as in Example 3, except that the amount of the binder resin relative to 100 parts by mass of the wax of the release layer coating liquid was changed to 30 parts by mass.

### Example 15

A thermal transfer recording medium was produced in the same manner as in Example 3, except that the amount of the binder resin relative to 100 parts by mass of the wax of the release layer coating liquid was changed to 31 parts by mass.

### Example 16

A thermal transfer recording medium was produced in the same manner as in Example 3, except that the average thickness of the release layer was changed to 0.1 micrometers.

### Example 17

A thermal transfer recording medium was produced in the same manner as in Example 3, except that the average thickness of the release layer was changed to 0.2 micrometers.

### Example 18

A thermal transfer recording medium was produced in the same manner as in Example 3, except that the average thickness of the release layer was changed to 1.0 micrometer.

### Example 19

A thermal transfer recording medium was produced in the same manner as in Example 3, except that the average thickness of the release layer was changed to 1.1 micrometers.

### Comparative Example 1

A thermal transfer recording medium was produced in the same manner as in Example 3, except that the binder resin was not added to the release layer coating liquid.

### Comparative Example 2

A thermal transfer recording medium was produced in the same manner as in Example 3, except that ethylene-propylene rubber-ethylidene norbornene rubber (EP11, available from JSR Corporation, ethylidene norbornene content: 0% by mass) was used as the binder of the release layer coating liquid.

### Comparative Example 3

A thermal transfer recording medium was produced in the same manner as in Example 3, except that styrene-butadiene rubber (SBN-215SL, available from JSR Corporation) was used as the binder of the release layer coating liquid.

### Comparative Example 4

A thermal transfer recording medium was produced in the same manner as in Example 3, except that butadiene rubber (BR810, available from JSR Corporation) was used as the binder of the release layer coating liquid.

### Comparative Example 5

A thermal transfer recording medium was produced in the same manner as in Example 3, except that ethylene-vinyl acetate (REV-523, available from Dow-Mitsui Polychemicals Company, Ltd.) was used as the binder of the release layer coating liquid.

TABLE 1

| | | | | Binder | | | | |
|---|---|---|---|---|---|---|---|---|
| | | | | | | | Amount of | |
| | | | | | | Ethyledene | binder per | |
| | Wax | | | Type of | | norbornen | 100 parts | Average |
| | | Melting | Penetration | binder | | content | by mass of | thickness |
| | Product name | point (° C.) | degree | resin | Product name | (mass %) | wax | (μm) |
| Ex. 1 | HNP-3 | 60 | 3 | A | EP51 | 5.8 | 10 | 0.5 |
| | NIPPON SEIRO | | | | JSR Corporation | | | |
| Ex. 2 | candelilla wax | 70 | 2 | A | EP51 | 5.8 | 10 | 0.5 |
| | S. KATO & CO. | | | | JSR Corporation | | | |
| Ex. 3 | carnauba wax | 85 | 2 | A | EP51 | 5.8 | 10 | 0.5 |
| | S. KATO & CO. | | | | JSR Corporation | | | |
| Ex. 4 | 4052E | 120 | 2 | A | EP51 | 5.8 | 10 | 0.5 |
| | Mitsui Chemical | | | | JSR Corporation | | | |
| Ex. 5 | 400PF | 130 | 2 | A | EP51 | 5.8 | 10 | 0.5 |
| | Mitsui Chemical | | | | JSR Corporation | | | |
| Ex. 6 | HNP-51 | 85 | 3 | A | EP51 | 5.8 | 10 | 0.5 |
| | NIPPON SEIRO | | | | JSR Corporation | | | |
| Ex. 7 | SX-80 | 85 | 4 | A | EP51 | 5.8 | 10 | 0.5 |
| | NIPPON SEIRO | | | | JSR Corporation | | | |
| Ex. 8 | carnauba wax | 85 | 2 | A | EP93 | 2.7 | 10 | 0.5 |
| | S. KATO & CO. | | | | JSR Corporation | | | |
| Ex. 9 | carnauba wax | 85 | 2 | A | EP22 | 4.5 | 10 | 0.5 |
| | S. KATO & CO. | | | | JSR Corporation | | | |
| Ex. 10 | carnauba wax | 85 | 2 | A | EP33 | 8.1 | 10 | 0.5 |
| | S. KATO & CO. | | | | JSR Corporation | | | |
| Ex. 11 | carnauba wax | 85 | 2 | A | EP331 | 11.3 | 10 | 0.5 |
| | S. KATO & CO. | | | | JSR Corporation | | | |
| Ex. 12 | carnauba wax | 85 | 2 | A | EP51 | 5.8 | 4 | 0.5 |
| | S. KATO & CO. | | | | JSR Corporation | | | |
| Ex. 13 | carnauba wax | 85 | 2 | A | EP51 | 5.8 | 5 | 0.5 |
| | S. KATO & CO. | | | | JSR Corporation | | | |
| Ex. 14 | carnauba wax | 85 | 2 | A | EP51 | 5.8 | 30 | 0.5 |
| | S. KATO & CO. | | | | JSR Corporation | | | |
| Ex. 15 | carnauba wax | 85 | 2 | A | EP51 | 5.8 | 31 | 0.5 |
| | S. KATO & CO. | | | | JSR Corporation | | | |
| Ex. 16 | carnauba wax | 85 | 2 | A | EP51 | 5.8 | 10 | 0.1 |
| | S. KATO & CO. | | | | JSR Corporation | | | |
| Ex. 17 | carnauba wax | 85 | 2 | A | EP51 | 5.8 | 10 | 0.2 |
| | S. KATO & CO. | | | | JSR Corporation | | | |
| Ex. 18 | carnauba wax | 85 | 2 | A | EP51 | 5.8 | 10 | 1.0 |
| | S. KATO & CO. | | | | JSR Corporation | | | |
| Ex. 19 | carnauba wax | 85 | 2 | A | EP51 | 5.8 | 10 | 1.1 |
| | S. KATO & CO. | | | | JSR Corporation | | | |
| Comp. | carnauba wax | 85 | 2 | NA | | | | 0.5 |
| Ex. 1 | S. KATO & CO. | | | | | | | |
| Comp. | carnauba wax | 85 | 2 | A | EP11 | 0 | 10 | 0.5 |
| Ex. 2 | S. KATO & CO. | | | | JSR Corporation | | | |
| Comp. | carnauba wax | 85 | 2 | B | SBN-215SL | NA | 10 | 0.5 |
| Ex. 3 | S. KATO & CO. | | | | JSR Corporation | | | |
| Comp. | carnauba wax | 85 | 2 | C | BR810 | NA | 10 | 0.5 |
| Ex. 4 | S. KATO & CO. | | | | JSR Corporation | | | |
| Comp. | carnauba wax | 85 | 2 | D | REV-523 | NA | 10 | 0.5 |
| Ex. 5 | S. KATO & CO. | | | | Dow-Mitsui | | | |

In Table 1, symbols for the binder are as follows.
A: ethylene-propylene-ethylidene norbornene rubber
B: styrene-butadiene rubber
C: butadiene rubber
D: ethylene-vinyl acetate

Next, various properties of each of the produced thermal transfer recording media were evaluated in the following manner. The results are presented in Table 2. The Bekk smoothness of the transfer-receptive paper was a value obtained by measuring by means of the Oken-type smoothness tester (available from KUMAGAI RIKI KOGYO Co., Ltd.).

<Scratch Resistance>

Printing was performed on transfer-receptive paper (C6, available from OSAKA SEALING PRINTING CO., LTD.) having Bekk smoothness of 2,000 seconds under the following conditions. The printed barcode was evaluated by rubbing 500 times (250 returns) with a pen (tip: glass ball) at a load of 200 g by means of a rub tester, and the result was evaluated based on the following criteria.

Printer: Zebra105SL Plus (available from Zebra Technologies Corporation)

Printing speed: 100 mm/sec

Set energy of printer: 14

—Evaluation Criteria—

A: The image was not peeled at all.

B: The image was partially peeled.

C: About the half of the image was peeled.

D: 80% or greater of the image was peeled.

<Binding Strength with Base>

The thermal transfer recording media was overlapped and stored with applying a load of 6 kg at 50 degrees Celsius for 3 days. Thereafter, the thermal transfer recording media was returned to room temperature, and the release layer and the base were peeled off from each other. At the time of peeling off, the degree of easiness of peeling between the base and the release layer was evaluated based on the following evaluation criteria.

—Evaluation Criteria—

A: The release layer and the base were not peeled off from each other at all.

B: The release layer and the base were very slightly peeled off from each other.

C: The release layer was partially peeled off from the base.

D: A half or greater area of the release layer was peeled off from the base.

<Thermal Sensitivity>

Printing was performed on transfer-receptive paper (C6, available from OSAKA SEALING PRINTING CO., LTD.) having Bekk smoothness of 2,000 seconds under the following conditions. The set energy of the printer with which ANSI grade [readability of the barcode (a ratio of absence of an error) represented with 5 stages of 0, 1, 2, 3, and 4] of the printed barcode was Bekk smoothness was 2.5 or greater was evaluated based on the following criteria.

—Printing Conditions—

Printer: Zebra105SL Plus (available from Zebra Technologies Corporation) Printing speed: 100 mm/sec

—Evaluation Criteria—

A: The set energy was less than 10.

B: The set energy was 10 or greater but less than 12.

C: The set energy was 12 or greater but less than 14.

D: The set energy was 14 or greater but less than 16.

E: The set energy was 16 or greater.

TABLE 2

| | Scratch | Binding strength | Thermal |
|---|---|---|---|
| | resistance | with base | sensitivity |
| Ex. 1 | B | A | A (6) |
| Ex. 2 | A | A | A (8) |
| Ex. 3 | A | A | B (10) |
| Ex. 4 | A | A | C (12) |
| Ex. 5 | A | A | D (14) |
| Ex. 6 | B | B | C (12) |
| Ex. 7 | C | B | B (10) |
| Ex. 8 | C | C | B (10) |
| Ex. 9 | B | B | B (10) |
| Ex. 10 | A | A | B (10) |
| Ex. 11 | A | A | B (10) |
| Ex. 12 | A | C | B (10) |
| Ex. 13 | A | B | B (10) |
| Ex. 14 | B | A | C (12) |
| Ex. 15 | C | A | D (14) |
| Ex. 16 | C | C | A (8) |
| Ex. 17 | B | B | A (8) |
| Ex. 18 | A | A | C (12) |
| Ex. 19 | B | B | D (14) |
| Comp. | B | D | B (10) |
| Ex. 1 | | | |
| Comp. | D | B | B (10) |
| Ex. 2 | | | |
| Comp. | D | B | B (10) |
| Ex. 3 | | | |
| Comp. | D | B | B (10) |
| Ex. 4 | | | |
| Comp. | D | B | B (10) |
| Ex. 5 | | | |

It was found from the results of Table 2 that the thermal transfer recording media of Examples 1 to 19 had excellent scratch resistance and base coherence, as well as high thermal sensitivity, compared to the thermal transfer recording media of Comparative Examples 1 to 5.

For example, the embodiments of the present disclosure are as follows.

<1> A thermal transfer recording medium including:
a base;
a release layer disposed on or above the base; and
a thermally fusible ink layer disposed on or above the release layer,
wherein the release layer includes wax and ethylene-propylene-ethylidene norbornene rubber.
<2> The thermal transfer recording medium according to <1>,
wherein the thermally fusible ink layer includes wax and a colorant.
<3> The thermal transfer recording medium according to <1> or <2>,
wherein an ethylidene norbornene content of the ethylene-propylene-ethylidene norbornene in the release layer is 4.5% by mass or greater.
<4> The thermal transfer recording medium according to any one of <1> to <3>,
wherein an amount of the ethylene-propylene-ethylidene norbornene rubber in the release layer is 5 parts by mass or greater but 30 parts by mass or less relative to 100 parts by mass of the wax included in the release layer.
<5> The thermal transfer recording medium according to any one of <1> to <4>,
wherein the wax in the release layer has a melting point of 70 degrees Celsius or higher but 120 degrees Celsius or lower.
<6> The thermal transfer recording medium according to any one of <1> to <5>,
wherein the wax in the release layer has a penetration degree of 3 or less.
<7> The thermal transfer recording medium according to any one of <1> to <6>,
wherein the release layer has an average thickness of 0.2 micrometers or greater but 1.0 micrometer or less.
<8> A transferred product including:
a transfer target on which at least part of the thermally fusible ink layer of the thermal transfer recording medium according to any one of <1> to <7> is transferred from the thermal transfer recording medium through thermal transfer.

The thermal transfer recording medium according to any one of <1> to <7> and the transferred product according to <8> can solve the above-described various problems existing in the art, and can achieve the object of the present disclosure.

### REFERENCE SIGNS LIST

1: base
2: release layer
3: thermally fusible ink layer
4: backing layer
10: thermal transfer recording medium

1: A thermal transfer recording medium, comprising:
a base;
a release layer disposed on or above the base; and
a thermally fusible ink layer disposed on or above the release layer,
wherein the release layer includes wax and ethylene-propylene-ethylidene norbornene rubber.

2: The thermal transfer recording medium according to claim 1, wherein the thermally fusible ink layer includes wax and a colorant.

3: The thermal transfer recording medium according to claim 1, wherein ylidene norbornene content of the ethylene-propylene-ethylidene norbornene rubber in the release layer is 4.5% by mass or greater.

4: The thermal transfer recording medium according to claim 1, wherein an amount of the ethylene-propylene-ethylidene norbornene rubber in the release layer is 5 parts by mass or greater but 30 parts by mass or less relative to 100 parts by mass of the wax included in the release layer.

5: The thermal transfer recording medium according to claim 1, wherein the wax in the release layer has a melting point of 70 degrees Celsius or higher but 120 degrees Celsius or lower.

6: The thermal transfer recording medium according to claim 1, wherein the wax in the release layer has a penetration degree of 3 or less.

7: The thermal transfer recording medium according to claim 1, wherein the release layer has an average thickness of 0.2 micrometers or greater but 1.0 micrometer or less.

8: A transferred product, comprising:
a transfer target on which at least part of the thermally fusible ink layer of the thermal transfer recording medium according to claim 1 is transferred from the thermal transfer recording medium through thermal transfer.
